(19) United States
(12) Patent Application Publication
(10) Pub. No.: US 2024/0283147 A1
(43) Pub. Date: Aug. 22, 2024

(54) TRANSMISSION MECHANISM AND ANTENNA

(71) Applicants: PROSE TECHNOLOGIES (SUZHOU) CO., LTD., Suzhou (CN); PROSE TECHNOLOGIES LLC, Mount Olive, NJ (US)

(72) Inventors: Xu WANG, Suzhou (CN); Yongzhong LI, Suzhou (CN); Peng LIU, Suzhou (CN); Junjie QIU, Suzhou (CN); Qun CHEN, Suzhou (CN)

(21) Appl. No.: 18/645,499

(22) Filed: Apr. 25, 2024

Related U.S. Application Data
(63) Continuation of application No. PCT/CN2022/077195, filed on Feb. 22, 2022.

(30) Foreign Application Priority Data
Nov. 8, 2021 (CN) 202111314948.0

(51) Int. Cl. H01Q 3/32; F16H 25/20; F16H 37/06; F16H 57/02; F16H 57/021; F16H 57/039

(52) U.S. Cl. CPC H01Q 3/32; F16H 25/2015; F16H 37/065; F16H 57/021; F16H 57/039; F16H 2057/02069; F16H 2057/0213

(57) ABSTRACT

A transmission mechanism includes: a drive shaft; and a stopper assembly, the stopper assembly including: a base, including a first thread; and a rotating component, positioned on the driving shaft, rotatable with the driving shaft, and including a second thread to engage the first thread, wherein at least one of the base and the rotating component is configured with a stopper; when the drive shaft rotates, the rotating component rotates with the drive shaft and slides relative to the base through an engagement of the first thread and the second thread; and when the stopper resists the base or the rotating component, a relative sliding between the base and the rotating component stops.

### RELATED APPLICATION(S)

This application is a continuation application of PCT Patent Application No. PCT/CN2022/077195, filed on Feb. 22, 2022, which claims priority to Chinese Patent application Ser. No. 20/211,1314948.0 filed with the National Intellectual Property Administration, People's Republic of China on Nov. 8, 2021, all of which are incorporated herein by reference in entirety.

### FIELD OF THE TECHNOLOGY

The present disclosure relates to the technical field of mobile communication antennas, and in particular to a transmission mechanism and an antenna including the transmission mechanism.

### BACKGROUND

In the technical field of mobile communications, antenna down tilt angle is a technical parameter worth consideration. Parameters such as angle, strength, and area of mobile signal coverage may change as the down tilt angle of the antenna changes. Antenna down tilt angle is often adjusted according to different situations. With the development of technology, electrically adjustable antennas with electrically adjustable down tilt angles have become more and more widely used. In an electrically adjustable antenna, multiple small phase shifters are usually arranged. These phase shifters are connected to the transmission device and are connected to multiple radiation elements through a feed network. When adjusting the electrical down tilt angle, the motor operates under the control of a control system and drives the medium panel of the phase shifter through the transmission device to drive the phase shifter to move, so that each radiation unit or combination of radiation elements obtains differential phase adjustment, thereby changing the down tilt angle of the antenna.

To improve the accuracy of phase adjustment, the initial phase shift position of the phase shifter may be calibrated. Certain existing transmission devices use a combination of screws, bases, and nuts to provide the motor with a starting position of rotation (corresponding to the initial phase shift position of the phase shifter). At least because these certain existing transmission devices use three and often more individual parts, a unwanted large structural fit gap often results, causing the initial phase shift position of the phase shifter to not be accurate enough, which in turn causes errors in phase adjustment.

### SUMMARY

Certain existing transmission devices use a combination of a screw, a machine base and a nut to provide a starting position for the motor. Since the above combination uses three parts, there is a large structural fit gap. As a result, the initial phase shift position of the phase shifter is not accurate enough, causing phase adjustment errors.

In a first aspect, the present disclosure provides a transmission mechanism. The transmission mechanism includes: a drive shaft; and a stopper assembly, the stopper assembly including: a base, including a first thread; and a rotating component, positioned on the driving shaft, rotatable with the driving shaft, and including a second thread to engage the first thread, where: at least one of the base and the rotating component is configured with a stopper; when the drive shaft rotates, the rotating component rotates with the drive shaft and slides relative to the base through an engagement of the first thread and the second thread; and when the stopper resists the base or the rotating component, a relative sliding between the base and the rotating component stops.

In certain embodiment(s) of the present disclosure, the stopper assembly includes two parts: a base and a rotating component. Since the stopper assembly uses fewer parts, the structural fit gap is also reduced accordingly. Therefore, using the stopper assembly can more accurately calibrate the initial phase shift position of the phase shifter, improving the accuracy of phase adjustment. Fewer parts also reduce the difficulty of assembly, reduce manufacturing costs, and impart higher cost-effectiveness.

In certain embodiment(s) of the present disclosure, the base is slidably installed on the drive shaft, and the rotating component is fixedly installed on the drive shaft.

In certain embodiment(s) of the present disclosure, the base is fixedly installed on the shaft, and the rotating component is slidably installed on the drive shaft.

In certain embodiment(s) of the present disclosure, the stopper is positioned on the base; when the drive shaft rotates, the rotating component slides in an axial direction of the drive shaft; and when the stopper resists the rotating component, the relative sliding between the base and the rotating component stops.

In certain embodiment(s) of the present disclosure, the stopper is an end of the first thread.

In certain embodiment(s) of the present disclosure, the base includes a first mating portion at an end of the first thread, and the rotating component includes a second mating portion at an end of the second thread, and when the rotating component is resisted by the stopper, the first matting portion and the second mating portion contact each other.

In certain embodiment(s) of the present disclosure, the transmission mechanism further includes: a driven shaft, positioned with an angle relative to the drive shaft; and a direction-changing assembly, configured to drive the driven shaft to rotate when the driving shaft rotates, where the direction-changing assembly includes: a worm, positioned on one of the drive shaft and the driven shaft; a first gear, positioned on the other of the drive shaft and the driven shaft; and a direction-changing mechanism engaging the worm and the first gear.

In certain embodiment(s) of the present disclosure, the worm is positioned on the drive shaft, and the first gear is position on the driven shaft.

In certain embodiment(s) of the present disclosure, neither the worm nor the first gear is located on a common vertical line between the drive shaft and the driven shaft.

In certain embodiment(s) of the present disclosure, a distance between the drive shaft and the driven shaft is smaller than a radius of the first gear.

In certain embodiment(s) of the present disclosure, the direction-changing mechanism includes a second gear different than the first gear.

In certain embodiment(s) of the present disclosure, a lead angle of the worm is smaller than a friction angle between the second gear and the worm.

In certain embodiment(s) of the present disclosure, one or both of the first gear and the second gear are a helical gear.

In certain embodiment(s) of the present disclosure, a diameter of the second gear is smaller than a diameter of the first gear.

In certain embodiment(s) of the present disclosure, a distance between a shaft of the second gear and the drive shaft is greater than a distance between the driven shaft and the drive shaft.

In certain embodiment(s) of the present disclosure, the direction-changing assembly further includes a position-limiting mechanism, and the position-limiting mechanism includes: a housing; and a partition wall, positioned in the housing and connected to the housing to form a position-limiting space together with the housing, in an assembled state, the worm, the direction-changing mechanism and the first gear are received in the position-limiting space.

In a second aspect, the present disclosure provides an antenna. The antenna includes a reflector; a phase shifter; and the transmission mechanism according to any embodiment of the first aspect.

In a third aspect, the present disclosure provides an antenna. The antenna includes: a reflector, configured with a receiving groove; a phase shifter; and the transmission mechanism according to any embodiment of the first aspect, where the direction-changing assembly of the transmission mechanism is at least partially received in the receiving groove.

### BRIEF DESCRIPTION OF THE DRAWINGS

The embodiments are shown and described with reference to the accompanying drawings. The drawings serve to illustrate certain principles, thereby showing only those aspects for an understanding of the principles. The drawings are not necessarily to scale. In the drawings, similar or same reference numbers indicate similar or same features.

FIG. 1 is a schematic diagram of a transmission mechanism according to certain embodiment(s) of the present disclosure, where the transmission mechanism includes a direction-changing assembly;

FIG. 2 is a schematic diagram of the position-limiting mechanism of FIG. 1, viewed from another angle;

FIG. 3 is a schematic diagram of installing the transmission mechanism of FIG. 1 to an antenna reflector;

FIG. 4 is a schematic diagram of a partial enlargement of area B of FIG. 3;

FIG. 5 is a schematic diagram of a stopper assembly included in a transmission mechanism according to certain embodiment(s) of the present disclosure;

FIG. 6A and FIG. 6B are respectively a schematic view of the base and the rotating component in the stopper assembly of FIG. 5, from different angles;

FIG. 7 is an exploded schematic diagram of a transmission mechanism before assembly according to certain embodiment(s) of the present disclosure, where the transmission mechanism includes a direction-changing assembly and a stopper assembly; and

FIG. 8 is a schematic diagram of the transmission mechanism of FIG. 7 after connection to the motor and the phase shifter.

Other features, characteristics, advantages, and benefits of the present disclosure in certain embodiment(s) become more apparent from the following detailed description taken in conjunction with the accompanying drawings.

### DETAILED DESCRIPTION

In the following detailed description of the embodiments, reference is made to the accompanying drawings, which form a part hereof. The accompanying drawings illustrate, by way of example, embodiments in which the present disclosure can be practiced. The illustrated embodiments are not intended to be exhaustive of all embodiments according to the present disclosure. Other embodiments may be utilized, and structural or logical modifications may be made without having to depart from the scope of the present disclosure. The following detailed description is therefore not to be taken in a limiting sense, and the scope of the present disclosure is defined by the appended claims.

Technical problems are associated with certain existing technologies. For example, the transmission device of the electrically adjustable antenna in certain existing technologies is often realized by using a large area of sheet metal or some complex mechanical structures, and it is difficult to make multiple sets of phase shifters to make a smooth and consistent movement, which affects the working accuracy of the phase shifter and the adjustment accuracy of the electrical down tilt angle.

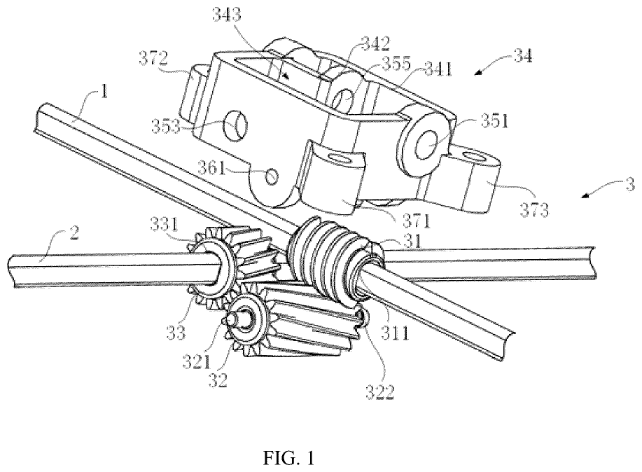

In view of the above technical problems, the present disclosure proposes a transmission mechanism. Referring to FIG. 1, the transmission mechanism includes a drive shaft 1, a driven shaft 2 positioned with an angle relative to the drive shaft 1, and a direction-changing assembly 3. In certain embodiment(s), and as illustratively shown in FIG. 1, the transmission mechanism includes only one driven shaft 2 and one direction-changing assembly 3. In certain embodiment(s), the transmission mechanism includes a plurality of driven shafts 2 and a plurality of direction-changing assemblies 3, each driven shaft is positioned with an angle to the driving shaft 1, and each direction-changing assembly 3 is connected to one of the plurality of driven shafts 2. The drive shaft 1 rotates under an action of an external driving force. The external driving force may be a driving force provided directly or indirectly by a motor, or a driving force provided directly or indirectly manually. In other words, the transmission mechanism may be used in both electrically adjustable antennas and manually adjustable antennas. When used in electrically adjustable antennas, the drive shaft 1 may be directly or indirectly connected to the motor. In certain embodiment(s), the direction-changing assembly 3 is used to drive the driven shaft 2 to rotate synchronously when the driving shaft 1 rotates. In certain embodiment(s), the direction-changing assembly 3 includes a worm 31, a direction-changing mechanism 32, and a first gear 33. As illustratively shown in FIG. 1, neither the worm 31 nor the first gear 33 is positioned on a common vertical line of the driving shaft 1 and the driven shaft 2. In other words, the worm 31 is not directly positioned above the first gear 33. The worm 31 is positioned on the drive shaft 1 and rotates with the drive shaft 1. In certain embodiment(s), neither the worm 31 nor the first gear 33 is positioned on the common vertical line of the driving shaft 1 and the driven shaft 2. In certain embodiment(s), one of the worm 31 and the first gear 33 can positioned on the common vertical line of the driving shaft 1 and the driven shaft 2. The direction-changing mechanism 32 is meshed with the worm 31. The first gear 33 is positioned on the driven shaft 2 and meshes with the direction-changing mechanism 32. In certain embodiment(s), the worm 31 is positioned on the driven shaft 2 and the first gear 33 is positioned on the driving shaft 1. In certain embodiment(s), and as illustratively shown in FIG. 1, the direction-changing mechanism 32 is a second gear, and both the direction-changing mechanism 32 and the first gear 33 are helical gears. In certain embodiment(s), the direction-changing mechanism 32 is a combination of multiple gears. Alternatively, the direction-changing mechanism 32 may also adopt other structures, as long as the direction-changing function may be achieved. In certain embodiment(s), and as illustratively shown in FIG. 1, the direction-changing mechanism 32 is a second gear, the axis of the second gear 32 is parallel to the driven shaft 2. In certain embodiment(s), a distance between the axis of the second gear 32 and the drive shaft 1 is greater than the distance between the driven shaft 2 and the drive shaft 1. The driven shaft 2 is connected to at least one phase shifter (not shown in FIG. 1), and then drives at least one phase shifter for synchronous phase adjustment when rotating.

In FIG. 1, the worm 31 is shown with a first central hole 311 in alignment with the drive shaft 1. In certain embodiment(s), the cross-sections of the drive shaft 1 and the first central hole 311 are non-circular. For example, the cross-sections of the drive shaft 1 and the first central hole 311 are both waist shaped. The worm 31 is positioned like a sleeve over the drive shaft 1 via the first central hole 311 and is fixed circumferentially on the drive shaft 1. The first gear 33 is shown as having a second central hole 331 that is in alignment with the driven shaft 2. For example, the driven shaft 2 and the second central hole 331 both have a waist-shaped cross-section. The first gear 33 is positioned as a sleeve over the driven shaft 2 via the second central hole 331 and is fixed circumferentially on the driven shaft 2. The worm 31 may be positioned on the drive shaft 1 in other forms, and the first gear 33 may also be positioned on the driven shaft 2 in other forms. In certain embodiment(s), neither the worm 31 nor the first gear 33 has a central hole, but are integrally formed with the drive shaft 1 and the driven shaft 2 respectively.

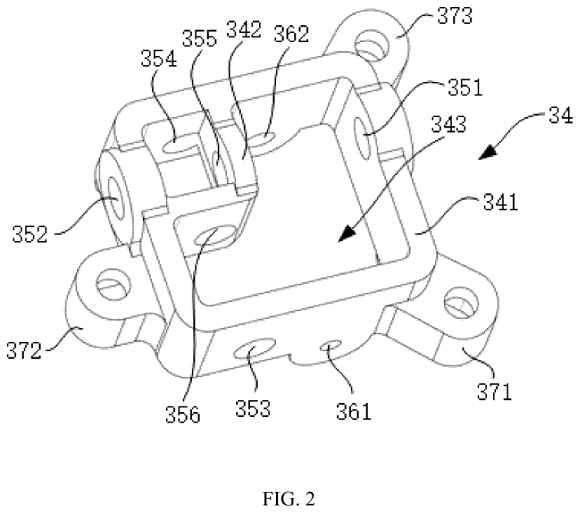

As shown in FIG. 1, and in certain embodiment(s), the direction-changing assembly 3 also includes a position-limiting mechanism 34. The position-limiting mechanism 34 includes a housing 341 and a partition wall 342. The partition wall 342 is positioned inside of the housing 341, and forms a position-limiting space 343 together with the housing 341. In certain embodiment(s), the partition wall 342 is connected to the housing 341. The size of the position-limiting space 343 is designed to be in alignment with the worm 31, the direction-changing mechanism 32 and the first gear 33. In an assembled state, the worm 31, the direction-changing mechanism 32 and the first gear 33 are accommodated in the limiting space 343, thereby preventing the worm 31, the direction-changing mechanism 32 and the first gear 33 from being displaced. As illustratively shown in FIGS. 1 and 2, the housing 341 is provided with first and second through holes 351 and 352 that are opposite to each other and third and fourth through holes 353 and 354 that are opposite to each other. The partition wall 342 includes a first part and a second part that are at an angle relative to each other. In certain embodiment(s), the first part is perpendicular to the second part. In certain embodiment(s), the first part and the second part are respectively provided with fifth through holes 355 and sixth through holes 356. The fifth through hole 355 is aligned with the first through hole 351 and the second through hole 352, and the sixth through hole 356 is aligned with the third through hole 353 and the fourth through hole 354. In an assembled state, the drive shaft 1 passes through the first through hole 351, the fifth through hole 355 and the second through hole 352 in sequence, and the driven shaft 2 passes through the third through hole 353, the sixth through hole 356 and the fourth through hole 354 in sequence.

Continuing to FIGS. 1 and 2, a pair of first positioning portions 361 and 362 are provided on the two side walls of the housing 341, and a pair of second positioning portions 321 and 322 are provided at both ends of the direction-changing mechanism 32. In certain embodiment(s), and as illustratively shown in FIGS. 1 and 2, the pair of first positioning portions 361 and 362 are shown in the form of openings, and the pair of second positioning portions 321 and 322 are shown in the form of protrusions. In an assembled state, a pair of protrusions 321 are respectively inserted into corresponding openings 361 or 362 to position the direction-changing mechanism 32. In certain embodiment(s), the first positioning portions and the second positioning portions are provided with other numbers and forms, as long as the direction-changing mechanism may be positioned by cooperating with each other.

In certain embodiment(s), and as illustratively shown in FIGS. 1 and 2, the housing 341 is also provided with three first fixing portions 371-373 for direct or indirect fixed connection with other components of the antenna (such as a reflector). In certain embodiment(s), and as illustratively shown in FIGS. 1 and 2, each first fixing portion extends outward from an outer surface of the housing 341 and has an opening. A fixing member such as a fixing pin may be used to pass through the opening and be fixed on other components of the antenna. In certain embodiment(s), the first fixing portion may also have other numbers and forms, as long as the housing 341 may be directly or indirectly fixedly connected to other components of the antenna. In certain embodiment(s), the position-limiting mechanism 34 shown in FIGS. 1 and 2 is only exemplary and may have other structures. In addition, the direction-changing assembly 3 may not include the position-limiting mechanism 34, but may be limited by other means.

In certain embodiment(s), by using the direction-changing assembly to change the transmission direction of an output power of the drive shaft, the number of phase shifters may be easily increased while ensuring the synchronization and consistency of the movement of the phase shifters, and has a relatively high expandability, and the weight and cost of the transmission are also low. In addition, direction change with the help of worm drive achieves a large reduction ratio, improves the transmission accuracy, and may drive multiple phase shifters with a small driving force. Therefore, when used in electrically adjustable antennas, multiple phase shifters may be driven with a small power motor. Furthermore, the stiffness of the shaft itself further ensures consistent rotation and hence smooth movement of the phase shifters.

In certain embodiment(s), the direction-changing mechanism 32 is a second gear, and the lead angle of the worm 31 is designed to be smaller than the friction angle between the second gear and the worm 31, thereby achieving reverse self-locking and effectuate stability when the phase shifters are in operation.

In certain existing technologies, a transmission device may use a complex mechanical structure, so it occupies a large area and has a large thickness. With the thinning and miniaturization of antenna products, the available space inside the antenna may be limited. It may be difficult for a large transmission device to be positioned inside the space available. The transmission mechanism according to certain embodiment(s) of the present disclosure allows the drive shaft 1 and the driven shaft 2 to positioned with angle relative to each other through the direction-changing mechanism 32, so that, in certain embodiment(s), the distance between the drive shaft 1 and the driven shaft 2 may be set to be smaller than a radius of the first gear 33 or the worm 31. In this way, the height of the transmission mechanism may be reduced, thereby reducing the occupied space and achieving the flattening, thinning and miniaturization of the entire antenna product.

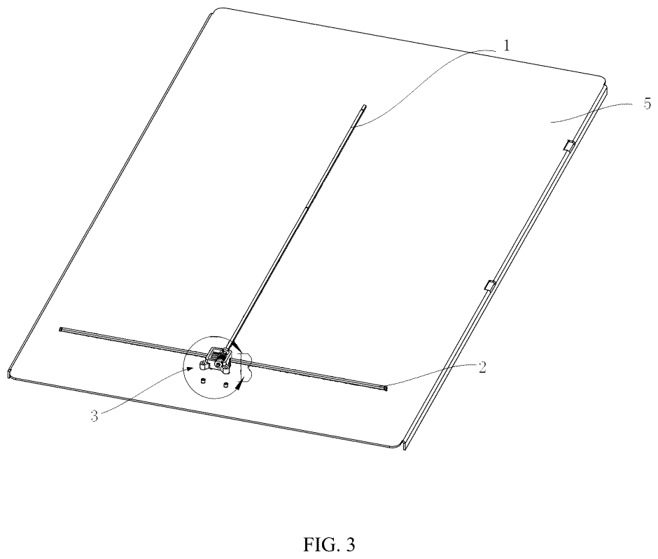

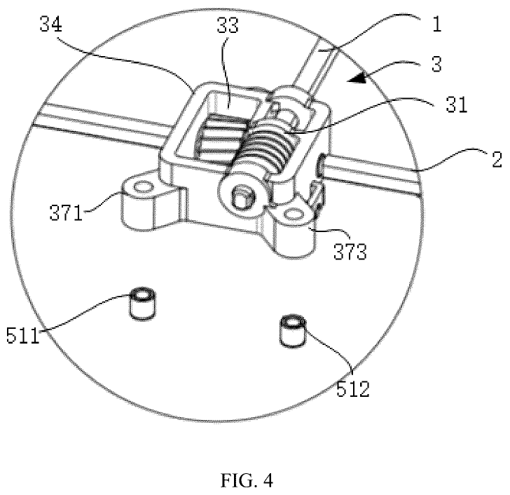

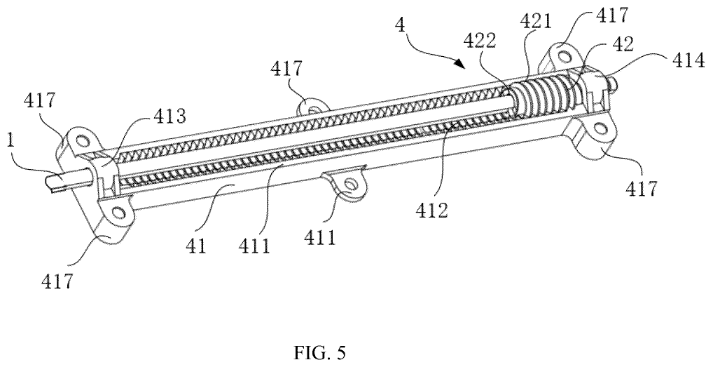

In certain embodiment(s), FIG. 3 shows a schematic diagram of installing the transmission mechanism of FIG. 1 on the antenna reflector, and FIG. 4 shows a partial enlarged view of area B in FIG. 3. The reflector 5 is provided with a receiving groove (not shown in FIGS. 3 and 4), the shape of which matches the shape of a projection of the direction-changing mechanism 32 on the reflector 5. When the transmission mechanism is installed on the reflector 5, a part of the direction-changing mechanism 32 is received in the receiving groove, thus reducing the thickness of the entire antenna product. In certain embodiment(s), the three first fixing portions 371-373 of the position-limiting mechanism 34 are respectively aligned with three fixing fitting parts on the reflector plate 5 (only two fixing fitting parts 511 and 512 are shown in the perspective of FIG. 5). Fixing elements such as pins fix the position-limiting mechanism 34 onto the reflector 5.

In certain existing transmission devices of the electrically adjustable antenna, technical problems exist where it may be difficult for the multiple groups of phase shifters to move smoothly and uniformly, and the working accuracy of the phase shifters and the adjustment accuracy of the electrical down tilt angle are affected. Other technical problems associated with those existing transmission devices exist where a combination of screws, bases and nuts are used to provide the motor with a starting position of rotation (corresponding to the initial phase shift position of the phase shifter). However, since the combination of those certain existing devices uses three component parts, a large structural fit gap results, which causes the initial phase shift position of the phase shifter to not be accurate enough, which in turn causes errors in the phase adjustment.

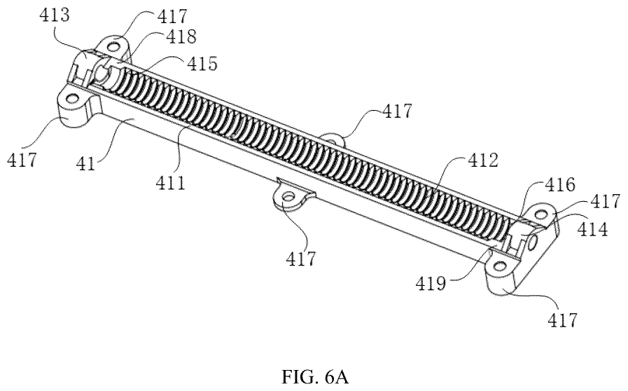

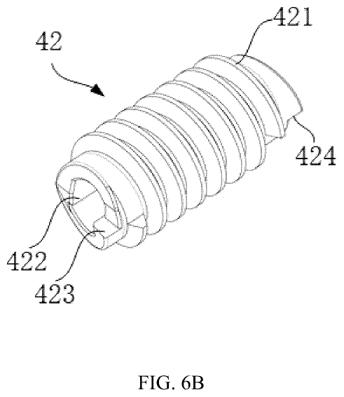

In certain embodiment(s), the present disclosure provides a transmission mechanism including a stop assembly, which is used to accurately calibrate the initial phase shift position of the phase shifter. FIG. 5 shows a schematic view of the stop assembly; FIGS. 6A and 6B respectively show a schematic view of a base and a rotating component in the stop assembly of FIG. from different angles. In certain embodiment(s), and as illustratively shown in FIGS. 5 and 6A-6B collectively, assembly 4 includes a base 41 and a rotating component 42. A surface 411 of the base 41 forms a first thread 412. The rotating component 42 is arranged on the drive shaft 1 and rotates with the drive shaft 1. A surface of the rotating component 42 forms a second thread 421 that aligns with or engages the first thread 412. When the drive shaft 1 rotates, the rotating component 42 rotates with the drive shaft 1 and slides relative to the base 41 through an engagement between the first thread 412 and the second thread 421. A stopper is provided on the base 41 and/or the rotating component 42. When the stopper resists the base 41 or the rotating component 42, the relative sliding between the base 41 and the rotating component 42 stops. In the assembled state, the position of the stopper corresponds to an initial phase-shifting position of the at least one phase shifter.

In certain embodiment(s), and as illustratively shown in FIG. 5, the rotating component 42 is in the form of a screw rod, which has a third central hole 422 that aligns with the drive shaft 1. For example, the cross-sections of the drive shaft 1 and the third central hole 422 are both waist shaped. The rotating component 42 is positioned on the drive shaft 1 like a sleeve via the third central hole 422 and is fixed circumferentially on the drive shaft 1. The rotating component 42 may be positioned on the drive shaft 1 in other forms. In certain embodiment(s), the rotating component 42 does not have a central hole but is integrally formed with the drive shaft 1.

In certain embodiment(s), and as illustratively shown in FIG. 5, the surface 411 of the base 41 is recessed inwardly and forms the first thread 412. In certain embodiment(s), the first thread 412 may be provided on the surface 411 of the base 41 in other forms. As illustratively shown in FIG. 5, the base 41 also has two opposing ends 413 and 414, and the surface 411 is positioned between the two ends 413 and 414. The two ends 413 and 414 respectively extend beyond the surface 411 and are respectively provided with through holes for the drive shaft 1 to pass through. In certain embodiment(s), the base is provided with one or more second fixing portions 417. In certain embodiment(s), the base 41 is also provided with six second fixing portions 417, two of which extend outward from a middle part of the base 41, and the other four second fixing portions extend from the two opposing ends 413 and 414 of the base 41, which are used for direct or indirect fixed connection with other components of the antenna (such as a reflector). One or more of second fixing portions 417 are each provided with an opening, a fixing member such as a fixing pin may pass through the opening for fixation onto other components of the antenna. In certain embodiment(s), the second fixing portion 417 may also have other numbers and forms, as long as the base 41 may be directly or indirectly fixedly connected to other components of the antenna.

In certain embodiment(s), and as illustratively shown in FIG. 6A, either end 415 or 416 of the first thread 412 functions as a stopper. The drive shaft 1 is directly or indirectly connected to the drive shaft of the motor (not shown in FIGS. 5 and 6A-6B) and rotates under the drive of the motor. When assembling the transmission mechanism and the phase shifters, the end 415 or 416 of the first thread 412 is selected as the stopper, and when the base 41 is fixed, a position of the stopper and an initial phase shift position of the phase shifter are set accordingly. Corresponding settings in the motor control system are also set, such as the rotation direction of the motor. In the assembled state, when the initial phase shift position is to be calibrated, the control system controls the motor to continue to rotate in a preset rotation direction, and the drive shaft 1 rotates when driven by the motor. The base 41 is fixed on other components of the antenna (such as the reflector) via one or more of the second fixing portions 417, and therefore remains stationary. The rotating component 42 rotates with the drive shaft 1 and slides along the drive shaft 1 toward a selected end of the first thread 412. When the rotating component 42 reaches the selected end, the rotating component 42 stops rotating and sliding axially. This provides the motor with a starting position of rotation that indicates that the phase shifter connected to the transmission mechanism has reached the initial phase shift position. The motor control system controls the motor to rotate in an opposite direction, and driven by the motor, the drive shaft 1 also rotates in the opposite direction and begins to phase shift the phase shifter.

In certain embodiment(s), and as illustratively shown in FIG. 5, the rotating component 42 slides along the drive shaft 1, where the base 41 is in a fixed position. In certain embodiment(s), the rotating component 42 may be fixed to the drive shaft 1 in a circumferential and an axial direction, where the rotating component 42 does not slide along the drive shaft 1, but the base 41 is set to be able to slide along the drive shaft 1. It is operational, as long as the base 41 and the rotating component 42 are driven by the driving shaft 1 and slide relative to each other through an engagement of the first thread 412 and the second thread 421.

FIG. 5 and FIGS. 6A-6B show an example of the stopper. In certain embodiment(s), the stopper may be located at other positions and/or have other forms, as long as the stopper may stop the relative sliding between the base 41 and the rotating component 42 and/or the rotation of the rotating component 42. In certain embodiment(s), the stopper is positioned at other locations on the base 41, such as any location on the first thread 412, to stop the rotation and/or sliding of the rotating component 42. In certain embodiment(s), the stopper is located on the rotating component 42. In certain embodiment(s), both the base 41 and the rotating component 42 are each provided with a stopper, for example, two stoppers that cooperate with each other are respectively provided at suitable locations on the base 41 and the rotating component 42. In certain embodiment(s), and when assembling the transmission mechanism and the phase shifter, the stopper or stoppers are positioned such that the stopper or stoppers correspond to the initial phase shift position of the phase shifter.

In certain embodiment(s), and as illustratively shown in FIGS. 6A and 6B, the base 41 includes a pair of first mating portions 418 and 419 respectively at two ends 415 and 416 of the first thread 412, and the rotating mechanism 42 includes a pair of second mating portions 423 and 424 respectively at two ends of the second thread 421. As illustratively shown in FIG. 5 and FIGS. 6A-6B, when the rotating component 42 reaches the end 416 of the first thread 412, the first mating portion 419 and the second mating portion 424 contact each other. When the rotating mechanism 42 slides along the driving shaft 1 toward the end 415 of the first thread 412 and reaches the end 415, the first mating portion 418 and the second mating portion 423 contact each other.

In certain embodiment(s), the stop assembly includes two parts: a base and a rotating component. Compared with certain existing technology, since the stop assembly according to certain embodiment(s) of the present disclosure uses fewer parts and the structural fit gap is correspondingly reduced, the initial phase shift position of the phase shifter may be calibrated more accurately using this stop assembly, thereby improving the adjustment efficiency of the phase shifter. Fewer parts also reduce the difficulty of assembly, reduce manufacturing costs, and have higher cost-effectiveness.

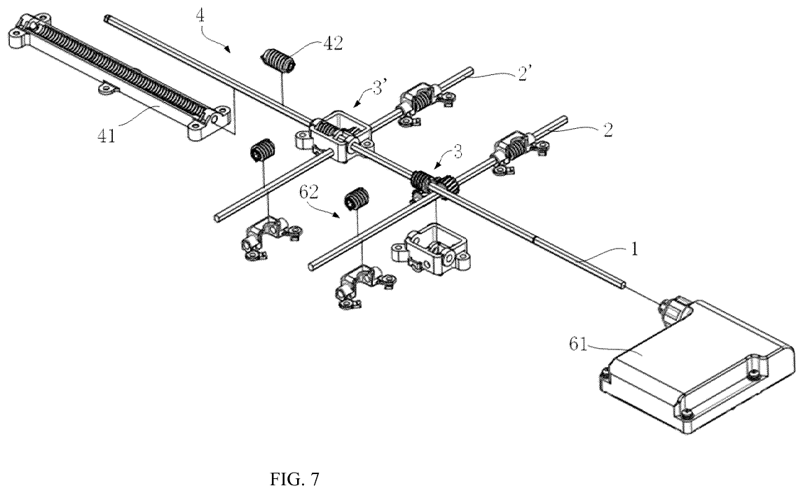

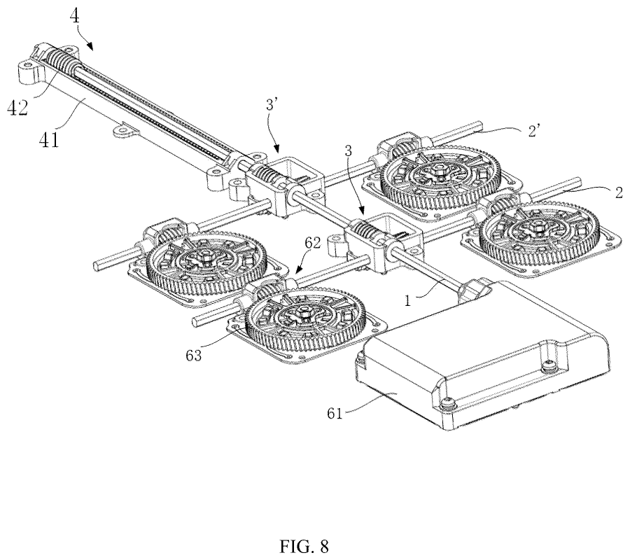

Refer next to FIG. 7 and FIG. 8. FIG. 7 shows an exploded schematic view of the transmission mechanism before assembly according to certain embodiment(s) of the present disclosure. The transmission mechanism includes a direction-changing assembly and a stopper assembly. FIG. 8 illustratively shows a schematic diagram of the transmission mechanism of FIG. 7 after connection to a motor and a phase shifter. In certain embodiment(s), the transmission mechanism includes two driven shafts 2 and 2′ and two direction-changing assemblies 3 and 3′. The drive shaft 1 is connected to a drive shaft of the motor 61 and rotates through a drive by the motor 61. The two driven shafts 2 and 2′ are each positioned with an angle relative to the driving shaft 1 respectively. The two direction-changing assemblies 3 and 3′ respectively convert the rotation of the drive shaft 1 into the rotation of the driven shafts 2 and 2′. The drive shaft 1 does not have to be directly connected to the drive shaft of the motor 61. In certain embodiment(s), the drive shaft 1 is driven by the motor 61 indirectly. For example, the direction-changing assembly 3 is used to convert the rotation of the drive shaft of the motor 61 into the rotation of the drive shaft 1.

In certain embodiment(s), the transmission mechanism also includes a stopper assembly 4 shown in FIG. 5. In certain embodiment(s), the direction-changing assembly 3 functions to help make the phase shifter move more smoothly and consistently, and thus to obtain a more desirable working accuracy of the phase shifter and adjustment accuracy of the electrical down tilt angle. In certain embodiment(s), the stopper assembly 4 functions to effect a smaller structural fit gap, and hence to make the initial phase shift position of the phase shifter to be more accurate. In certain embodiment(s), the transmission mechanism include both the direction-changing assembly 3 and the stopper assembly 4. In certain embodiment(s), the transmission mechanism include one of but not both of the direction-changing assembly 3 and the stopper assembly 4. In certain embodiment(s), the transmission mechanism includes at the same time both the direction-changing assembly 3 and the stopper assembly 4.

In certain embodiment(s), and as illustratively shown in FIG. 7 and FIG. 8, two drive assemblies 62 are positioned on each driven shaft relative to the direction-changing assembly 3, and each drive assembly 62 is used to drive a shift movement of phase shifters 63 through the rotation of the driven shaft. In certain embodiment(s), the two drive assemblies 62 are positioned symmetrically relative to a corresponding direction-changing assembly 3. In certain embodiment(s), one of more of the drive assemblies 62 include a worm circumferentially fixed on the driven shaft and a fixing mechanism for defining the position of the worm. The fixing mechanism is fixed on other components of the antenna (such as a reflector) via fixing pieces. The worm of the drive assembly 62 meshes with an external gear of a phase shifter 63. When the driven shaft rotates, the worm of the drive assembly 62 rotates accordingly, thereby driving the external gear of the phase shifter 63 to rotate, thereby performing phase adjustment. The structure of the drive assembly 62 is not limited to the form shown in FIGS. 7 and 8. In certain embodiment(s), the drive assembly 62 is of any suitable form and structure, as long as the drive assembly 62 is positioned to drive the phase shifter 63 to perform phase shifting driven by the driven shaft 2 or 2′.

In certain embodiment(s), one end of the first thread on the base 41 is used as a stopper to stop the rotating component 42. Through pre-arrangement, the position of the end corresponds to the initial phase-shifting position of the plurality of phase shifters 63 (that is, the working starting position of the motor). In certain embodiment(s), and to calibrate the initial phase shift position of the phase shifter, under the control of the control system, the motor 61 drives the drive shaft 1 to continuously rotate, so that the rotating component 42 rotates with the drive shaft 1 and moves along the drive shaft 1 toward the end (as a stopper) of the first thread. The rotation of the drive shaft 1 is transmitted to the driven shafts 2 and 2′ via the direction-changing assemblies 3 and 3′, and driven by the multiple drive assemblies 62, the multiple phase shifters move toward their initial phase shifting positions. When the rotating component 42 reaches the end, the rotating component 42 cannot continue to rotate and slide, and the second mating portion on the rotating component 42 abuts against the first mating portion at the end. The plurality of phase shifters 63 are located at their initial phase shifting positions, the control system controls the motor 61 to reverse rotate, and the plurality of phase shifters 63 begin to shift phase. Since the stopper assembly uses fewer parts, the structural fit gap is also reduced accordingly. Therefore, using the stopper assembly can more accurately calibrate the initial phase shift position of the phase shifter, improving the accuracy of phase adjustment. Fewer parts also reduce the difficulty of assembly, reduce manufacturing costs, and impart higher cost-effectiveness.

During the phase shifting process, the motor 61 determines the number of rotation turns through the control signal sent by the control system, and the number of rotation turns corresponds to the phase to be adjusted by the phase shifter 63. The drive shaft 1 rotates under the drive of the motor 61, and the direction-changing assemblies 3 and 3′ convert the rotation of the drive shaft 1 into the rotation of the two driven shafts 2 and 2′. Driven by multiple drive assemblies 62, multiple phase shifters 63 perform phase adjustment, and in certain embodiments, the multiple phase shifters 63 perform synchronous phase adjustment. The rotating component 42 rotates with the drive shaft 1 and slides along the drive shaft 1. In certain embodiment(s), the first thread on the base 41 is designed with sufficient length, such that during the phase shifting process, the rotating component 42 does not reach the end of the first thread and be stopped. The direction-change effectuated with the help of worm drive achieves a large reduction ratio, improves the transmission accuracy and makes it possible to drive multiple phase shifters with a small driving force. Furthermore, the stiffness of the shaft itself further helps with consistent rotation and therefore smooth phaser movement.

In certain embodiment(s), four phase shifters are employed, as illustratively shown in FIGS. 7 and 8. In certain embodiment(s), in an antenna product, such as a MIMO antenna, more than four phase shifters may be employed, such as 16, 32, 64, or the like phase shifters and radiation elements may be employed. In certain embodiment(s), more phase shifters are provided on the driven shafts 2 and 2′ as needed, or several more driven shafts 2 and 2′ and corresponding direction-changing assemblies 3 are added. Multiple phase shifters may be configured on the driven shaft. Arrangement of the phase shifter 63 on the driven shaft (such as being symmetrical with respect to the direction-changing assembly 3 or being located at one side of the direction-changing assembly 3) may also be determined according to certain considerations (such as the size of the space within the antenna). In certain embodiment(s), multiple third shafts and corresponding multiple direction-changing assemblies may be staggered on each driven shaft, and the rotation of the driven shaft is converted into the rotation of the third shaft through the direction-changing assembly, thereby driving multiple phase shifters that are connected to the driving shaft, driven shaft and/or third shaft to perform synchronous phase adjustment. Therefore, using this transmission mechanism may easily increase the number of phase shifters, has good scalability, and the weight and cost of the transmission are also low.

In certain embodiment(s), and as illustratively shown in FIGS. 7 and 8, the stopper assembly 4 is provided at the rear end of the drive shaft 1. In certain embodiment(s), the position of the stopper assembly 4 may be set as desirable, for example, the stopper assembly 4 is arranged at the front of the drive shaft 1 (such as between the driven shaft 2 and the motor 61) or in the middle of the drive shaft 1 (such as between the two driven shafts 2 and 2′).

In certain embodiment(s), the present disclosure provides an antenna, including: a reflector or a reflector plate; at least one phase shifter; and a transmission mechanism according to any one of the above embodiments. In certain embodiment(s), a receiving groove is provided on the reflector plate, and a portion of the direction-changing mechanism 32 is received within the receiving groove, thereby reducing the height of the transmission mechanism. Receiving grooves may be provided when desirable. In certain embodiment(s), when the diameter of the direction-changing mechanism 32 (such as the second gear) is greater than or equal to the diameter of the first gear 33, a receiving groove is provided to shorten the distance between the driven shaft 2 and the reflector plate, thereby reducing the thickness of the antenna assembly. In certain embodiment(s), and when the diameter of the direction-changing mechanism 32 is smaller than the diameter of the first gear 33, the receiving groove may not be provided. In certain embodiment(s), the distance between the drive shaft 1 and the driven shaft 2 is close to zero, such as zero plus or minus 0.5 centimeter, as long as there is no measurable friction between the drive shaft 1 and the driven shaft 2. In certain embodiment(s), a portion of the direction-changing mechanism 32 and a portion of the first gear 33 are received in the receiving groove, thereby further shortening the distance between the driven shaft 2 and the reflector plate. In certain embodiment(s), the distance between the driven shaft 2 and the reflector plate is close to zero, such as zero plus or minus 0.5 centimeter.

Although certain embodiments of the present disclosure have been described, various changes and modifications may be made without having to depart from the spirit and scope of the present disclosure, to achieve one or some of the advantages of the present disclosure. Other components performing similar or the same function may be appropriately substituted for or employed. Features described with reference to a figure may be combined with features of other figures, even where this is not explicitly mentioned. Such modifications of the solution according to the present disclosure are intended to be covered by the appended claims.

What is claimed is:

1. A transmission mechanism, comprising:
a drive shaft; and
a stopper assembly, including:
a base, including a first thread; and
a rotating component, positioned on the driving shaft, rotatable with the driving shaft, and including a second thread to engage the first thread, wherein:
at least one of the base and the rotating component is configured with a stopper;
when the drive shaft rotates, the rotating component rotates with the drive shaft and slides relative to the base through an engagement of the first thread and the second thread; and
when the stopper resists the base or the rotating component, a relative sliding between the base and the rotating component stops.

2. The transmission mechanism of claim 1, wherein the base is slidably installed on the drive shaft, and the rotating component is fixedly installed on the drive shaft.

3. The transmission mechanism of claim 1, wherein the base is fixedly installed on the shaft, and the rotating component is slidably installed on the drive shaft.

4. The transmission mechanism of claim 1, wherein the stopper is positioned on the base; when the drive shaft rotates, the rotating component slides in an axial direction of the drive shaft; and when the stopper resists the rotating component, the relative sliding between the base and the rotating component stops.

5. The transmission mechanism of claim 4, wherein the stopper is an end of the first thread.

6. The transmission mechanism of claim 4, wherein the base includes a first mating portion at an end of the first thread, and the rotating component includes a second mating portion at an end of the second thread, and when the rotating component is resisted by the stopper, the first matting portion and the second mating portion contact each other.

7. The transmission mechanism of claim 1, further comprising:
a driven shaft, positioned with an angle relative to the drive shaft; and
a direction-changing assembly, configured to drive the driven shaft to rotate when the driving shaft rotates, wherein the direction-changing assembly includes:
a worm, positioned on one of the drive shafts and the driven shaft;
a first gear, positioned on the other of the drive shaft and the driven shaft; and
a direction-changing mechanism engaging the worm and the first gear.

8. The transmission mechanism of claim 7, wherein the worm is positioned on the drive shaft, and the first gear is positioned on the driven shaft.

9. The transmission mechanism of claim 7, wherein neither the worm nor the first gear is located on a common vertical line between the drive shaft and the driven shaft.

10. The transmission mechanism of claim 7, wherein a distance between the drive shaft and the driven shaft is smaller than a radius of the first gear.

11. The transmission mechanism of claim 7, wherein the direction-changing mechanism includes a second gear different than the first gear.

12. The transmission mechanism of claim 11, wherein a lead angle of the worm is smaller than a friction angle between the second gear and the worm.

13. The transmission mechanism of claim 11, wherein one or both of the first gear and the second gear are a helical gear.

14. The transmission mechanism of claim 11, wherein a diameter of the second gear is smaller than a diameter of the first gear.

15. The transmission mechanism of claim 11, wherein a distance between a shaft of the second gear and the drive shaft is greater than a distance between the driven shaft and the drive shaft.

16. The transmission mechanism of claim 7, wherein the direction-changing assembly further includes a position-limiting mechanism, and the position-limiting mechanism includes:
a housing; and
a partition wall, positioned in the housing and connected to the housing to form a position-limiting space together with the housing, in an assembled state, the worm, the direction-changing mechanism and the first gear are received in the position-limiting space.

17. An antenna, comprising:
a reflector;
a phase shifter; and
the transmission mechanism of claim 1.

18. An antenna, comprising:
a reflector, configured with a receiving groove;
a phase shifter; and
the transmission mechanism of claim 7, wherein the direction-changing assembly of the transmission mechanism is at least partially received in the receiving groove.
